(19) United States
(12) Patent Application Publication
(10) Pub. No.: US 2019/0300722 A1
(43) Pub. Date: Oct. 3, 2019

(54) BINDERS STABILIZED IN AN AQUEOUS PHASE

(71) Applicant: Chemetall GmbH, Frankfurt (DE)

(72) Inventors: Wolfgang Bremser, Paderborn (DE); Martin Droll, Paderborn (DE); Oliver Seewald, Paderborn (DE); Evgenija Niesen-Warkentin, Paderborn (DE); Lars Schachtsiek, Paderborn (DE); Manuel Traut, Paderborn (DE); Michael Schwamb, Frankfurt (DE); Daniel Wasserfallen, Frankfurt (DE); Nawel Souad Khelfallah, Frankfurt (DE); Vera Sotke, Frankfurt (DE); Aliaksandr Frenkel, Frankfurt (DE); Ron Eilinghoff, Frankfurt (DE); Stephanie Gerold, Frankfurt (DE); Felix Kleimenhagen, Brugg (CH)

(21) Appl. No.: 16/308,206

(22) PCT Filed: Jun. 8, 2017
(86) PCT No.: PCT/EP2017/063913

§ 371 Date: Dec. 7, 2018

(30) Foreign Application Priority Data
Jun. 10, 2016 (DE) 102016210336.9

(51) Int. Cl. C09D 5/08; C08G 18/83; C08G 18/42; C08G 18/32; C08G 18/34; C08G 18/66; C08G 18/76; C09D 175/16; C09D 5/02; C09D 7/40

(52) U.S. Cl. CPC C09D 5/084; C08G 18/831; C08G 18/42; C08G 18/3206; C08G 18/348; C08G 2150/90; C08G 18/7671; C09D 175/16; C09D 5/028; C09D 7/67; C09D 7/68; C08G 18/6659

(57) ABSTRACT

Binders stabilized in an aqueous phase and capable of codeposition with ionogenic gel-formers are disclosed. The binder may be a resin or polymer, including polyacrylates, polyurethanes, polyepoxides, urethane acrylates, aromatic and (cyclo)-aliphatic epoxy acrylates, polyesters, and mixtures thereof. The binders are modified by reactions between reactive groups on the binder and hydrophilic, functional molecules. Reactive groups on the binder may include isocyanates, hydroxyls, carboxyls, oxiranes, vinyls and amines. A method of producing such dispersions is disclosed.

The invention relates to binders stabilized in an aqueous phase and to particles which are capable of codeposition with ionogenic gel-formers and whose binder is selected from the group consisting of polyacrylates, polyurethanes, polyepoxides, urethane acrylates, aromatic and (cyclo)-aliphatic epoxy acrylates, polyesters, and a mixture thereof. Particles are understood in this sense to be organic and inorganic pigments, functional fillers, and a mixture thereof.

The documents WO 2012034976 A1, WO 2013117611 A1 and WO 2015004256 A1 disclose methods for electroless coating of metallic substrate surfaces that utilize anionically, zwitterionically, sterically, cationically and/or nonionically stabilized binders and deposit them rinse-resistantly by ionogenic gel formation, with addition of polyelectrolytes, and also solidify them by drying and also baking.

In view of the industrial utilization of methods for the electroless coating of various substrate surfaces, especially those of various metals, by means of ionogenic gel formation, and also of the increasing requirements imposed on the coatings in respect of corrosion resistance and scratch resistance, there is an interest in providing a broad spectrum of binders for the formation of stable aqueous dispersions. The dispersions obtained are intended to be deposited by ionogenic gel formation with addition of polyelectrolytes. The rinse resistance of the deposited gels is an important criterion here and in the case of a rinsing process is required to withstand the typical industry spraying pressure of at least 0.2 bar, or an immersive rinsing process, withstanding here meaning that the deposited film does not undergo detachment. A uniform, impervious coating is formed on the metallic surface.

The problem addressed by the invention is that of describing binders stabilized in an aqueous phase, and a method for producing such dispersions. The binders thus stabilized, referred to hereinafter as carrier binders, form stable aqueous dispersions which, with addition of polyelectrolytes, under induction by metal cations, form ionogenic gels on various substrate surfaces. These films are notable for very good rinse resistance, withstanding a spraying pressure of at least 0.2 bar or an immersive rinsing process, to leave, after rinsing, a uniform, impervious film. In accordance with the present invention, a stable aqueous dispersion is a colloidal aqueous solution in which the particles are held apart from one another by forces of repulsion.

Furthermore, for the purposes of the present invention, polyelectrolytes are: polysaccharides which serve for the ionogenic deposition and which have already been described at length in the specifications WO 2012034976 A1, WO 2013117611 A1 and WO 2015004256 A1.

Substrate surfaces contemplated are as follows: metallic substrates, such as steel, galvanized steel, aluminum, and alloy thereof, and metallically doped materials.

In accordance with the invention, the problem is solved by means of carrier binders which are stabilized in an aqueous phase and which are capable of codeposition with ionogenic gel-formers, where a binder is modified by means of reactive groups on the binder with a hydrophilic, functional molecule. The carrier binder may be a resin or polymer. It is preferably selected from the group consisting of polyacrylates, polyurethanes, polyepoxides, urethane acrylates, aromatic and (cyclo)-aliphatic epoxy acrylates, polyesters, and also a mixture thereof, which are modified by hydrophilic, functional molecules, by means of reactive groups on the binder, and are stabilized in an aqueous phase. Reactive groups on the binder in the sense of the present invention are: isocyanates, hydroxyls, carboxyls, oxiranes, vinyls and amines.

The hydrophilic, functional molecule is advantageously a telomer which is provided with a hydrophobic end group and is composed of ethylene glycol units, the number of ethylene glycol units in the telomer being 1 to 20. A number of ethylene glycol units in the range from 5 to 10 is an advantage, since in that case there is a good balance between hydrophilic-hydrophobic fractions.

With particular preference the hydrophilic, functional molecule has a molecular weight Mn between 300 and 1000 g/mole.

With very particular preference the hydrophilic, functional molecule possesses a C₁-C₄ alkyl or a C₆-C₁₂ aryl end group.

To produce the carrier binder there is covalent attachment of the hydrophilic, functional molecule to the binder. The carrier binder thus produced forms a stable dispersion in aqueous phases, at least over a period of 6 months, preferably of up to 12 months or more.

In one particularly advantageous variant, the hydrophobic end group of the hydrophilic, functional molecule that is not attached to the original binder is reactive. For the purposes of the present invention, this refers to vinyl or hydroxyl groups which are able to undergo further reaction thermally. The groups may contribute to crosslinking either by radical reaction or by addition reactions or condensation reactions during the baking operation. As a result it is possible to produce a crosslinked, impervious coating which is resistant to water, chemicals and corrosion and which exhibits enhanced scratch resistance, pencil hardness, high flexibility, stretchability, low-temperature formability, and great adhesion.

The particles stated above are advantageously surface-modified with silanes, aminosilanes, phosphorus-group-containing and/or amine-containing organic molecules, phosphates, or with conductive or nonconductive organic coatings, it being possible for the coatings to comprise reactive groups for covalent or interactional attachment to the carrier binder, said groups having functional groups for attachment to the substrate surface that is to be treated. Particles which have no reactive groups or unsuitable reactive groups for attachment on their surfaces may be made available by adsorption of the hydrophilic, functional molecules on their surfaces.

The method of the invention for producing a carrier binder involves modifying the original binder by reaction of the reactive groups of the binder to form 1 to 9 chain units of the hydrophilic, functional molecule.

The carrier binders produced have additional emulsifying properties and are able as a result to permit the ionogenic deposition of other binders and particles.

One nonexclusive possibility for producing a carrier binder described is the reaction of a hydrophilic, functional molecule by a urethane-forming reaction. The reaction is performed, depending on the viscosity, preferably in the presence of organic solvents, which are subsequently removed.

An isocyanate-functionalized polyethylene glycol molecule is used as hydrophilic component and a polyester polyol is used which has a molecular weight Mn in the range from 1000 to 3000 g/mole. Reactive groups present on the original binder are hydroxyl groups, which are capable of forming urethane bonds.

The polyester polyol used advantageously comprises reactive groups in the range from 100 g/eq to 5000 g/eq.

A further preferred production of a carrier binder takes place in the manner described below:

A polyethylene glycol molecule (preferably polyethylene glycol methyl ether) functionalized with a polycyclic isocyanate (e.g. Desmodur® VL) is reacted and covalently bonded with diisopropylamine (DIPA) or with DIPA and/or preferably butoxime (or other ketoximes), or other isocyanate-reactive molecules carrying functional groups.

Reactive groups present are hydroxyl groups or, preferably, secondary amines on the molecules, which are capable of formation of, for example, urethane bonds or urea derivatives.

One particularly preferred variant of a carrier dispersion based on polyurethane (PU) dispersion with acrylate-terminated polymer chains is described in the following synthesis method. This PU dispersion-based carrier dispersion, in the presence of the emulsifying carrier binders set out above, leads to particularly rinse-resistant coatings with high corrosion protection. The original PU binder is preferably modified by initially introducing the binder with an isocyanate-terminated form in a first stage, and reacting it with the hydrophilic, functional molecule, by urethane formation, in a second stage.

The hydrophilicity of the PU dispersion-based carrier dispersion with acrylate-terminated polymer chains may be increased by addition of emulsifiers based on tertiary amines such as fatty acid-modified emulsifiers with terminal hydrophilic tertiary amine compounds such as the commercially available FAME® EFKA6225, allowing sufficient stabilization to take place in the pH range to pH 3.

The invention is elucidated in more detail below using four examples.

### EXAMPLE 1: PRODUCTION OF A POLYURETHANE ACRYLATE DISPERSION, HYDROXYETHYL METHYLACRYLATE-TERMINATED (PUD-HEMA)—DISPERSION I

The experimental setup consists of a 500 mL glass reactor with reflux condenser, a stirring guide with gas inlet, an RPG stirring motor and a close-clearance anchor stirrer. Heating is carried out using a magnetic stirrer with heating function and temperature sensor and also a silicone oil bath. Operation is to take place in the absence of water and under a continual flow of nitrogen throughout the reaction. At the start, the polyester polyol Priplast® 3192 or Priplast® XL 101 from Croda) is introduced in butan-2-one and this initial charge is homogenized at 65° C. for 10 minutes (min) at a stirrer speed of 120 rpm. Subsequently the diol, neopentyl glycol (NPG), and the carboxyl-containing diol, 2,2-bis-hydroxymethyl-propionic acid (DMPA) as chain extender, are added and homogenization takes place for a further 15 min. Thereafter the diisocyanate, 4,4-diphenylmethane diisocyanate, is added.

The temperature of the solution is maintained at 82° C., corresponding to an outer jacket temperature of 94° C., for 6 h.

After 6 h, the partially hydrophilic building blocks for the end group are added, in the form of 2-hydroxyethyl methacrylate (HEMA). After about 80 min, dimethylethanolamine is added in order to neutralize the carboxyl functions. When this has taken place, ethylene glycol monobutyl ether is added to the reaction. Finally, the DI water is added, cooling takes place with continual stirring, and the solvent is removed on a rotary evaporator.

Determination of the solids fraction gave a value of 22.71 wt %. The particle size of the polymer is around 73 nm, determined using a Nano Zetasizer.

### EXAMPLE 2: PRODUCTION OF A POLYURETHANE ACRYLATE DISPERSION, POLYETHYLENE GLYCOL METHACRYLATE-TERMINATED (PUD-PEGMA500)—DISPERSION II

In a 500 mL glass reactor with reflux condenser, a stirring guide with gas inlet, an RPG stirring motor and a close-clearance anchor stirrer, the polyester polyol Priplast® 3192 from Croda is introduced in butan-2-one and this initial charge is homogenized at 65° C. for 10 min at a stirrer speed of 120 rpm. Subsequently the diol, neopentyl glycol (NPG), and the carboxyl-containing diol, 2,2-bis-hydroxymethyl-propionic acid (DMPA) as chain extender, are added, and homogenization takes place for a further 15 min. Thereafter the diisocyanate, 4,4-diphenylmethane diisocyanate, is added. The temperature of the solution is held at 82° C., corresponding to an outer jacket temperature of 94° C., for 6 h. After 6 h, the partially hydrophilic building blocks for the end group are added in the form of poly(ethylene glycol) methacrylate having an average numerical mean of the molecular weight Mn=500 g/mole (PEGMA-500). After about 80 min, dimethylethanolamine is added in order to neutralize the carboxyl functions. When this has taken place, ethylene glycol monobutyl ether is added to the reaction. Finally, the DI water is added, and the reaction is subsequently cooled for 30 minutes with continual stirring, and the solvent is removed on a rotary evaporator. The solids fraction of PUD-PEGMA500 is 25 wt %. The particle size of the polymer is around 73 nm, as measured using a Nano Zetasizer and with a solids content (SC) of 24.80 wt %.

Formulation Priplast®-3192-PUD-PEGMA-500 is indicated below

| Compound | Structure | Initial mass [g] |
|---|---|---|
| Polyester polyol | 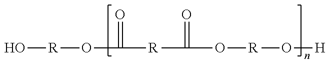 | 321.6 |
| Methyl ethyl ketone | 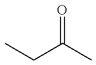 | 800.01 |
| 4,4-Diphenylmethane diisocyanate | 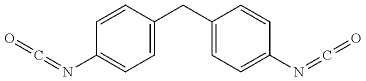 [SMILES: O=C=Nc1ccc(Cc2ccc(N=C=O)cc2)cc1] | 100.12 |
| Neopentyl glycol | 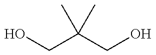 | 2.9157 |
| 2,2-Bis-hydroxymethyl- propionic acid | 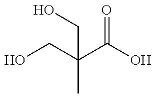 | 19.2087 |
| 2-Hydroxyethyl methacrylate | 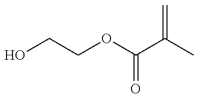 | — |
| Poly(ethylene glycol) methacrylate | 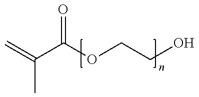 | 32.2031 |
| Dimethylethanolamine | 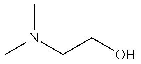 | 10.2109 |
| Ethylene glycol monobutyl ether | 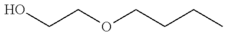 | 28.0333 |
| Double-distilled water | 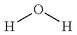 | 1000.01 |

A formulation of a coating material which withstands a spraying pressure of 0.5 bar is obtained from the following mixture:

Formulation consisting of 2.5 g of dispersion I, 2.5 g dispersion II and 5 g of blocked isocyanate crosslinker with polyethylene glycol units as carrier dispersion and is mixed by means of an Ultraturrax (IKA T 10 basic ULTRA-TURRAX®-IKA with S 10 N-10 G dispersing tool) on level 4 for 10 min. Introduction takes place with a shearing forces such as to form a uniform micelle, so that the overall mixture is sufficiently stable on pH reduction.

Alternatively, in the case of larger amounts of the mixture (1 kg), it is also possible, for example, to use laboratory dispersers with low viscosity blades, which are engaged at 2000 rpm for around 30 min in order to generate a correspondingly homogeneous distribution of the constituents.

Particularly high corrosion protection is additionally generated with the addition of around 1-2 g of bisphenol A-diglycidyl ether (BADGE) or with bisphenol F diglycidyl ether.

Thereafter, 12 g of a 1 wt % strength solution of the gel-former are added and incorporated by stirring overnight. The solids content of dispersion I and II is adjusted for this application to 20 wt %-25 wt %.

### EXAMPLE 3: SYNTHESIS METHOD FOR CARRIER DISPERSION

A further preferred mixing variant with high rinse resistance and high corrosion protection is the mixture of two as carrier dispersions, consisting of a polyacrylate-DPE carrier dispersions with a further carrier dispersion, which as hydrophilic isocyanate crosslinker is equipped with a polyethylene glycol methyl ether, such as, for example, the product BL 5335 from Covestro+BADGE, which form a rinse-resistant coating.

The two-stage synthesis is carried out in a 5 L glass reactor with close-clearance double anchor stirrer. Also mounted are reflux condenser, nitrogen inlet and outlet, bubble counter, heating jacket with thermostat, and the Gravidos feed. In the first stage, the reactor is charged with 1300 g of water, and heated to 40° C. with a stirrer speed of 120 rps and a full stream of nitrogen. When the 40° C. has been reached, the nitrogen stream is reduced to 1 bubble/s. Subsequently 25 g of styrene, 21.8 g of polyethylene glycol methyl ether methacrylate Mn 500 g/mole, and 2.055 g of 1,1-diphenylethylene are added. 100 g of water are added for subsequent rinsing. Leave the solution with stirring for around 5 min, then dissolve 4.056 g of ammonium peroxodisulfate in 100 g of water and add. The solution is then heated to 90° C. within a temperature-time ramp of around 45 min.

In the second stage, a mixture of 500 g of butyl methacrylate and 25 g of hydroxyethyl methacrylate is added dropwise from a Gravidos container by means of the Gravidos system over the course of 4 hours at a metering rate of around 2.188 g/min. From a second Gravidos container, 50 g of an epoxy acrylic acid in 50 g of butanone is metered in with a metering rate of 0.416 g over 4 hours. The epoxy acrylic acid is prepared as described below. The butanone is removed from the reactor again partly via the nitrogen stream. Alternatively it may be removed almost completely afterward, on a rotary evaporator. Following the complete addition of the monomers, stirring is continued at 90° C. for 2 hours. The dispersion is cooled, filtration takes place, and then determinations are made of the particle size of the solids and pH and also of the solids content (SC).

To this dispersion, which accordingly has approximately a SC of 40 wt %, it is then possible to add 10-50 wt % of BL 5335. In that case it is necessary to prepare approximately the 1-1.2-fold amount of polysaccharide solution with an SC of 1 wt % and to mix it with the dispersion for around 24 h.

### EXAMPLE 4: SYNTHESIS METHOD, CARRIER BINDER WITH EMULSIFIER PROPERTIES

The experimental setup consists of a 500 mL glass rector with reflux condenser, a stirring guide with gas inlet, an RPG stirring motor and a close-clearance anchor stirrer. Heating is carried out using a magnetic stirrer with heating function and temperature sensor and also a silicone oil bath. Operation is to take place in the absence of water and under a continual stream of nitrogen throughout the reaction.

At the start, polyethylene glycol methyl ether Mn 750 g/mole and 79.8 g of a polycyclic methyldiphenyl isocyanate (MDI) such as Desmodur® VL from Covestro or Bayer are introduced and this initial charge is heated at 70° C. for 2 hours with continual stirring at 120 rpm using an anchor stirrer. Then 17.4 g of butoxime are added with stirring and the components react at an internal reactor temperature of 70° C. for 2 h. Thereafter 20.21 g of diisopropylamine are added and stirring is carried out at 70° C. for 40 min. The complete conversion in the reaction can be monitored with the aid of infrared spectra (IR spectra) from the decrease in the isocyanate bands at a wavenumber between 2200 and 2400 cm⁻¹. The binder is subsequently adjusted to a solids fraction of 35-40 wt % using double-distilled water, and, with continual stirring and also with introduction of shearing forces, a dispersion is produced which has an emulsifying action for various types of resin such as, for example, bisphenol A diglycidyl ether or PUD resins.

1. A carrier binder stabilized in an aqueous phase and capable of codeposition with ionogenic gel-formers, wherein a binder is modified by means of reactive groups on the binder with a hydrophilic, functional molecule.

2. The carrier binder according to claim 1, wherein a binder which with an ionogenic gel forms a rinse-resistant coating having a rinse resistance of at least 0.2 bar spraying pressure or after an immersive rinsing process, where the binder constitute a core of the carrier binder micelles, which form micelles by means of polyurethanes with ethylene glycol units which are equipped with hydrophobic end groups.

3. The carrier binder according to claim 2, wherein the binder is a resin or polymer.

4. The carrier binder according to claim 1, wherein the hydrophilic, functional molecule is a telomer which is provided with a hydrophobic end group and is composed of ethylene glycol units, the number of ethylene glycol units in the telomer being 1 to 20.

5. The carrier binder according to claim 1, wherein the hydrophilic, functional molecule has a molecular weight between 300 and 1000 g/mole.

6. The carrier binder according to claim 1, wherein the hydrophilic, functional molecule possesses a C₁-C₄ alkyl or a C₆-C₁₂ aryl end group.

7. The carrier binder according to claim 1, wherein the hydrophobic end group of the hydrophilic, functional molecule is reactive.

8. The carrier binder according to claim 1, which comprises inorganic particles having a particle size of 5 nm to 800 nm in an amount of 0.01 to 50 wt %.

9. The carrier binder according to claim 8, wherein the inorganic particles are selected from the group consisting of color-effect and luster-effect pigments, anticorrosion pigments, UV protection pigments, or particles having other functional properties, without causing premature gelling of the dispersion through formation of polyvalent cations.

10. The carrier binder according to claim 9, wherein the inorganic particles are surface-modified with silanes, aminosilanes, phosphorus-group-containing and/or amine-containing organic molecules, phosphates, or with conductive or nonconductive organic coatings, it being possible for the coatings to comprise reactive groups for covalent or interactional attachment to the carrier binder.

11. The carrier binder according to claim 10, wherein the reactive groups of the inorganic particles are primary, secondary, tertiary amine, epoxy, isocyanate or hydroxyl groups.

12. A method for producing a carrier binder stabilized in an aqueous phase according to claim 1, wherein the binder is modified by reaction of the reactive groups of the binder to form 1 to 9 chain units of the hydrophilic, functional molecule.
